(19) United States
(12) Patent Application Publication
(10) Pub. No.: US 2016/0378686 A1
(43) Pub. Date: Dec. 29, 2016

(54) MEMORY ENCRYPTION EXCLUSION METHOD AND APPARATUS

(71) Applicant: Intel Corporation, Santa Clara, CA (US)

(72) Inventors: Nicholas J. Adams, Beaverton, OR (US); Vincent J. Zimmer, Federal Way, WA (US); Baiju V. Patel, Portland, OR (US); Rajesh Poornachandran, Portland, OR (US)

(21) Appl. No.: 14/749,301

(22) Filed: Jun. 24, 2015

(51) Int. Cl. G06F 12/14; G06F 21/57

(52) U.S. Cl. CPC G06F 12/1408; G06F 21/575; G06F 21/572; G06F 2212/1052

(57) ABSTRACT

Apparatuses, methods and storage medium associated with memory encryption exclusion are disclosed herein. In embodiments, an apparatus may include one or more processors, memory, and firmware to provide basic input/output services to an operating system. Additionally, the apparatus may include a memory controller to control access to the memory, wherein the memory controller includes an encryption engine to encrypt data, using an encryption key, before the data are stored into an encrypted area of the memory, wherein the encryption engine regenerates the encryption key on a reset transferring execution from the operating system operated by the one or more processors to a pre-boot phase of the firmware. Further, the apparatus may include one or more storage locations to store one or more memory parameters to set aside one or more ranges of the memory as one or more encryption excluded areas. Other embodiments may be described and/or claimed.

### TECHNICAL FIELD

The present disclosure relates to the field of computing. More particularly, the present disclosure relates to the provision of one or more encryption exclusion areas in memory.

### BACKGROUND

The background description provided herein is for the purpose of generally presenting the context of the disclosure. Unless otherwise indicated herein, the materials described in this section are not prior art to the claims in this application and are not admitted to be prior art by inclusion in this section.

One of the historical challenges in the provision of a computing platform (hereinafter platform) includes the seamless implementation of firmware updates and passing other telemetry information back into the platform. Traditionally, vendors have their own utilities, custom drivers, and boot environments to orchestrate their updates. The emergency of the Unified Extensible Firmware Interface (UEFI) technology introduced the ability to use a Capsule, or binary blob with a payload and application, to carry these updates and/or provision of telemetry information. Along with the runtime application programming interface (API) UpdateCapsule( ) service, an operating system (OS) runtime is able orchestrate the update or passing of telemetry information while the OS is active (i.e., no need for a reboot into a custom environment, etc.) Windows®8 of Microsoft Corporation provided this capability to the system-on-chip (SOC) platforms. Follow on Windows® OS as well as other OS are expected to provide this capability to additional platforms. For further information on Capsule, see “Intel® Platform Innovation on Framework for EFI Capsule Specification,” version 0.9, September 2013, available from Intel® Corp.

However, other platform hardware protection technologies are competing with the Capsule mechanism. Specifically, the Capsule Update API often uses system memory as a transport of the capsule data which is conveyed across a non-memory destructive restart into the platform firmware. New technology like Total Memory Encryption (TME), though, considers the platform firmware hostile and any invocation back into the firmware across a restart/reset could be considered an attack vector wherein OS secrets might be revealed to the firmware, which may have been comprised. As a result, TME hardware implementations typically scramble the encryption key across restart/reset to ameliorate this concern.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates a computing device having the memory encryption exclusion technology of the present disclosure, according to various embodiments.

FIG. 2 illustrates various example memory parameters for configuring an encryption exclusion area in memory, according to various embodiments.

FIG. 3 illustrates the example encryption exclusion using base address and mask in further detail, according to various embodiments.

FIG. 4 illustrates an example process for providing an encryption exclusion area during reset, according to the various embodiments.

FIG. 5 illustrates an example process for verifying a capsule, according to various embodiments.

FIG. 6 illustrates an example computer system suitable for use to practice aspects of the present disclosure, according to various embodiments.

FIG. 7 illustrates a storage medium having instructions for practicing methods described with references to FIGS. 4-5, according to various embodiments.

### DETAILED DESCRIPTION

Apparatuses, methods and storage medium associated with memory encryption exclusion are disclosed herein. In embodiments, an apparatus may include one or more processors, memory, and firmware to provide basic input/output services to an operating system. Additionally, the apparatus may include a memory controller to control access to the memory, wherein the memory controller includes an encryption engine to encrypt data, using an encryption key, before the data are stored into an encrypted area of the memory, wherein the encryption engine regenerates the encryption key on a reset transferring execution from the operating system operated by the one or more processors to a pre-boot phase of the firmware. Further, the apparatus may include one or more storage locations to store one or more memory parameters to set aside one or more ranges of the memory as one or more encryption excluded areas.

In embodiments, the basic input/output services of the firmware may include one or more encryption exclusion services that configure the one or more memory parameters to set aside the range of the memory to provide the encryption excluded area of the memory or unset a previously set aside range of the memory to no longer exclude the area from encryption.

In embodiments, the basic input/output services of the firmware may further include a system reset service, wherein the system reset service includes a first of the one or more encryption exclusion services, wherein the first encryption exclusion service, on invocation during a beginning of a reset transferring execution from the operating system to the pre-boot phase of the firmware, sets the one or more memory parameters to set aside a range of the memory as the encryption excluded area. Additionally, the system reset service, as part of resetting the apparatus, may copy a capsule created by the operating system from the encrypted area into the encryption excluded area. Further, the basic input/output services of the firmware may include an initialization service that includes a second of the encryption exclusion service, where the second encryption exclusions service, on invocation during an end of the pre-boot phase, resets the one or more memory parameters to unset the set aside range of the memory to no longer exclude the area from encryption.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that like elements disclosed below are indicated by like reference numbers in the drawings.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

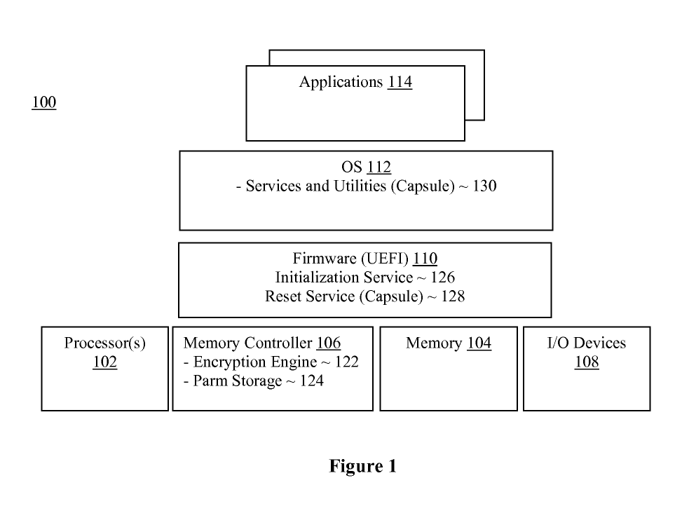

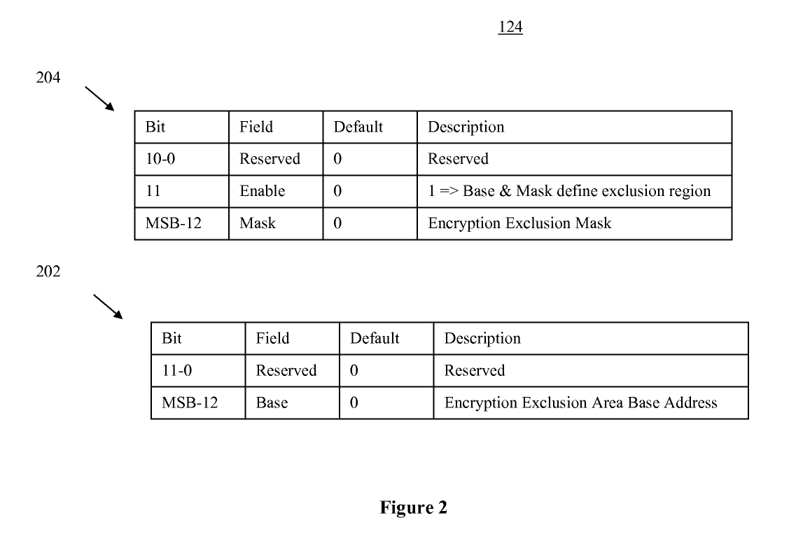

Referring now to FIG. 1, wherein a computing device having the memory encryption exclusion technology of the present disclosure, according to various embodiments, is shown. As illustrated, computing device 100 may include one or more processors 102, memory 104, and memory controller 106. Each of processors 102 may be any one of a number of processors known in the art, having one or more processor cores. Likewise, memory 104 may be any known volatile or non-volatile memory in the art, suitable for storing data. Memory controller 106 may be configured to control accesses to memory 104. In embodiments, memory controller 106 may include encryption engine 122 configured to encrypt data using an encryption key, by default, before storing the data into memory 104, unless the data are being stored into an area of memory 104 excluded from encryption. Additionally, encryption engine 122 may scramble the encryption key on reset, causing all encrypted data to be “lost” on entry into a reset. In embodiments, memory controller 106 may further include one or more storage locations, e.g., registers, to store one or more parameters configured to define one or more areas or ranges of memory 104 to be excluded from having data stored therein encrypted. In other words, by default, memory controller 106 provides total memory encryption (TME), augmented with selectable exclusion of one or more areas or ranges of memory 104. Except for the selectable exclusion of one or more areas or ranges of memory 104, memory controller 104 may be any one of a number of memory controllers known in the art. Selectable exclusion of one or more areas or ranges of memory 104 from encryption, and its usage will be further described below with references to FIGS. 2-5.

Still referring to FIG. 1, computing device 100 may further include a number of input/output (I/O) devices 108. Examples of I/O devices may include communication or networking interfaces, such as Ethernet, WiFi, 3G/4G, Bluetooth®, Near Field Communication, Universal Serial Bus (USB) and so forth, storage devices, such as solid state, magnetic and/or optical drives, input devices, such as keyboard, mouse, touch sensitive screen, and so forth, and output devices, such as, display devices, printers, and so forth.

Additionally, computing device 100 may include firmware 110, OS 112 and applications 114. Applications 114 may be any one of a number of applications known in the art. OS 112 may include various services and utilities 130, including a service for creating one or more capsules with data to be used by, or to update firmware 110. In embodiments, OS 112 may cause a system reset to pass the one or more capsules to firmware 110. Accordingly, OS 112 may likewise be any one of a number of OS known in the art.

Firmware 110 may include a number of basic input/output services. In embodiments, these basic input/output services may include initialization services 126 to be performed during a pre-boot/initialization phase, e.g., at start up of computing device 100, and a reset service 128 to reset computing device 100. In embodiments, firmware 110 may implement and support UEFI, and initialization services 126 may implement and support a number of pre-boot phases, including a pre-EFI initialization (PEI) phase, a driver execution environment (DXE) and a boot device selection phase (BDS). For these embodiments, initialization services 126 may further support verification and/or processing of capsules during the pre-boot phases.

In embodiments, the basic input/output services of firmware 110 may include one or more encryption exclusion services to configure the one or more memory parameters to set aside the one or more ranges of the memory to provide the one or more encryption excluded areas of the memory or unset the previously set aside one or more ranges of the memory to no longer exclude the one or more areas from encryption. In embodiments, reset service 128 may include a first of the one or more encryption exclusion services to configure, at the beginning of a reset, the memory parameters in parameter storage 124 to set aside one or more ranges of memory 104 as one or more encryption excluded areas, and use the one or more encryption excluded areas to transfer the one or more capsules created by OS 112 to the firmware 110 for verification and processing during the pre-boot phases. For these embodiments, initialization services 126 may include a second of the one or more encryption exclusion services to configure, at the end of the pre-boot phases, the memory parameters in parameter storage 124 to unset the previously set aside one or more ranges of memory 104 to no longer be excluded from having data to be stored into the one or more areas encrypted.

In embodiments, in addition to or in lieu of reset service 128, the second encryption exclusion service of initialization service 126 may be configured to configure, during the pre-boot phase at each power up, the memory parameters in parameter storage 124 to set aside one or more ranges of memory 104 as one or more encryption excluded areas. The one or more encryption excluded areas so created may persist across resets, until the computing device 100 is powered down.

In embodiments, the encryption exclusion service, whether it is part of reset service 128 or initialization service 126, may be executed out of a special protected memory area. An example of a special protected memory area may be a special memory area that is swapped in during a special protected execution mode, such as a system management mode. The special protected execution mode may be entered e.g., through an interrupt, such as an unmaskable interrupt.

For ease of understanding, the remaining description will generally be presented in the context of setting aside a range of the memory as an encryption excluded area, however, the disclosure is not so limited. The description applies to the setting of two or more ranges of the memory as two or more encryption excluded areas at any one time.

Referring now to FIG. 2, wherein various example memory parameters for configuring an encryption exclusion area in memory, according to various embodiments, are illustrated. As shown, the parameter storage 124 may include two storage locations 202 and 204 for storing two memory parameters, an encryption exclusion base address and an encryption exclusion mask. The encryption exclusion base address may identify the starting address of the encryption exclusion area. The encryption exclusion mask may be used the mask out certain bits of the memory address of a write operation, and in combination with the encryption exclusion base address, effectively defines the extent of the encryption excluded area (from the encryption exclusion base address). As described earlier, in embodiments, storage locations 202 and 204 may be two respective registers of memory controller 106. For the illustrated embodiments, the encryption exclusion base address and the encryption exclusion mask may be respectively stored in bits 12 and above (up to the most significant bit (MSB)) of storage locations/registers 202 and 204. The sizes of the base address and mask fields may depend on the size of memory 104, and/or the largest extent of encryption excluded area can be set aside. For the illustrated embodiments, bit 11 of storage location/register 204 may be used to store an enable indicator to indicate whether the feature of setting aside a range of memory 104 as encryption excluded area is enabled, e.g., with the value 0 indicating the feature being disabled, and the value 1 indicating the feature being enabled.

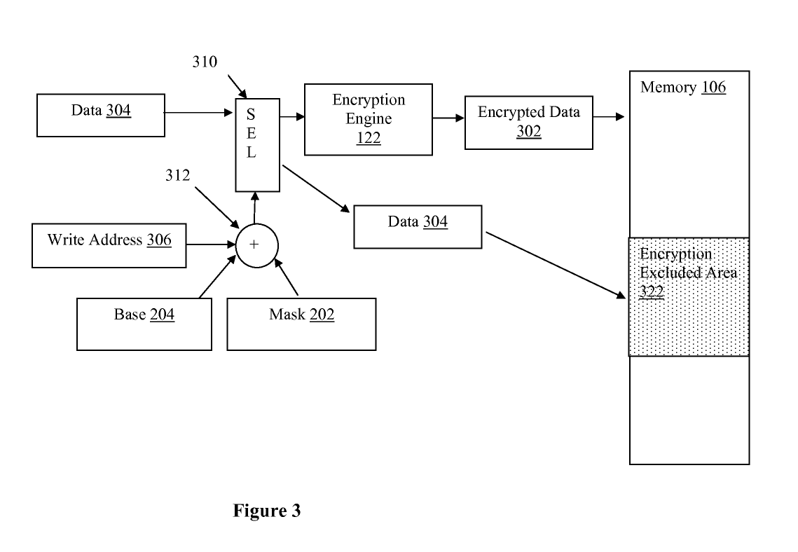

Referring now to FIG. 3 wherein the example encryption exclusion using base address and mask, according to various embodiments, is illustrated in further detail. As shown, a write address 306 may be combined 312 with base address 204 and mask 202 to generate a control signal to control a selector 310 in selecting whether to write the plain text data 304 or the encrypted data 302 (encrypted by encryption engine 122) in memory 106. The operations effectively achieve encryption exclusion for the extent/area 322. While for ease of understanding, the combination (masking) logic 312, selector 310 and encryption engine 122 are shown as separate elements, in embodiments, two or more of these elements may be combined into the same circuitry block.

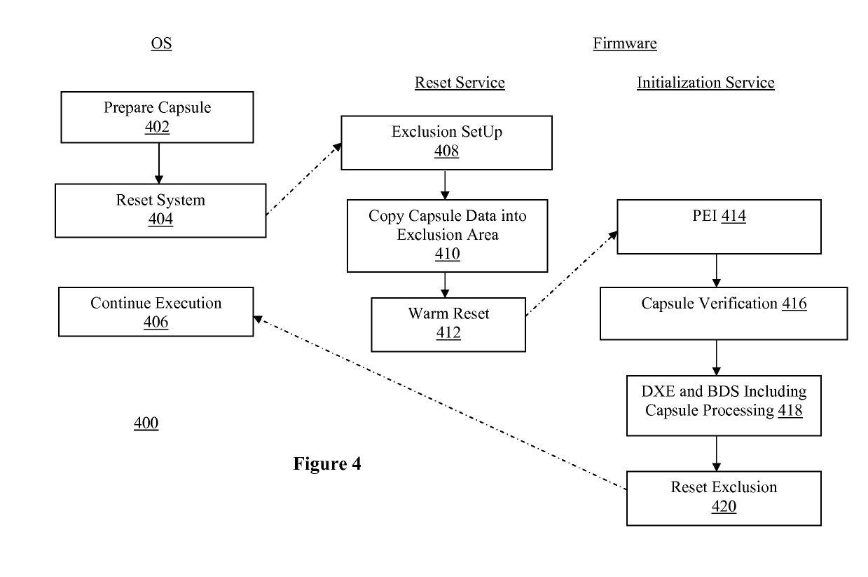

Referring now to FIG. 4 wherein an example process for providing an encryption exclusion area during a reset, according to the various embodiments, is illustrated. Example process 400 for providing an encryption exclusion area in a memory will be described in the context of embodiments where the encryption exclusion area is dynamically created at the beginning of a reset and removed at the end of a reset. As shown, for the illustrated embodiments, process 400 for providing an encryption exclusion area in a memory may include operations performed at blocks 402-420. The operations at blocks 402-406 may be performed e.g., by OS 112 of FIG. 1, and the operations at blocks 408-420 may be performed, e.g., by firmware 110 of FIG. 1. In particular, operations at blocks 408-412 may be performed by e.g., reset service 128, and operations at blocks 414-420 may be performed by e.g., initialization service 126. In alternate embodiments, process 400 may include more or less operations, or some of the operations may be performed in different order.

Process 400 may start at block 402. At block 402, a capsule may be prepared, e.g., by OS 112. As described earlier, the capsule may include data to be used by or to update firmware 110. Note that for these embodiments, during creation of the capsule, there is no encryption excluded area, as a result, the capsule stored in the memory is encrypted.

Next, at block 404, the system may be reset to transfer execution control from OS 112 to the pre-boot phase of firmware 110. At such time, reset service 128 may be invoked and given control. Process 400 may proceed to block 408.

At block 408, the encryption excluded area in memory may be set up, e.g., by reset service 128; more specifically, an encryption exclusion service of reset service 128. The encryption excluded area may be set up, e.g., by configuring the applicable memory parameters, such as the earlier described base address and mask. In embodiments, as described earlier, the encryption exclusion service of reset service 128 may be executed from a special protected memory, which is swapped in under a special protected execution mode. The special protected execution mode may be invoked via an interrupt.

Next, at block 410, the capsule data may be copied into the encryption excluded area, e.g., by reset service 128, resulting in the capsule data being stored in memory in their plain text. In embodiments, the capsule data may be copied from various discontiguous memory blocks in the encryption area into a contiguous memory block in the encryption excluded area.

Then, at block 412, a warm reset may be performed, e.g. by reset service 128, causing firmware 110 to enter into the pre-boot phase, with execution control transferred to initialization service 126.

At block 414, performance of operations associated with the PEI phase may commence. In particular, at block 416, verification of the capsule may be performed. At block 418, operations associated with the pre-boot DXE and BDS phases, including capsule processing, may be performed. In embodiments, the BDS phase may include extracting capsule data in accordance with the description information in the hand-off block (HOB) in header section of the capsule. And the extracted capsule data are processed during the DXE phase.

On completion of the operations, the memory parameters may be reconfigured again, e.g., by initialization service 126, more specifically, by an encryption exclusion service of initialization service 126, to return the encryption excluded area to a default encryption area. In embodiments, as described earlier, the encryption exclusion service of initialization service 126 may be executed from a special protected memory, which may be swapped in under a special protected execution mode. The special protected execution mode may be invoked via an interrupt. On returning the encryption excluded area to a default encryption area, the pre-boot phase may end with execution control returned to OS 112, where execution of OS 112 and application 114 may continue. Operations associated with pre-boot PEI, DXE and BDS phases are platform dependent, and known in the art, accordingly will not be further described, except for capsule verification.

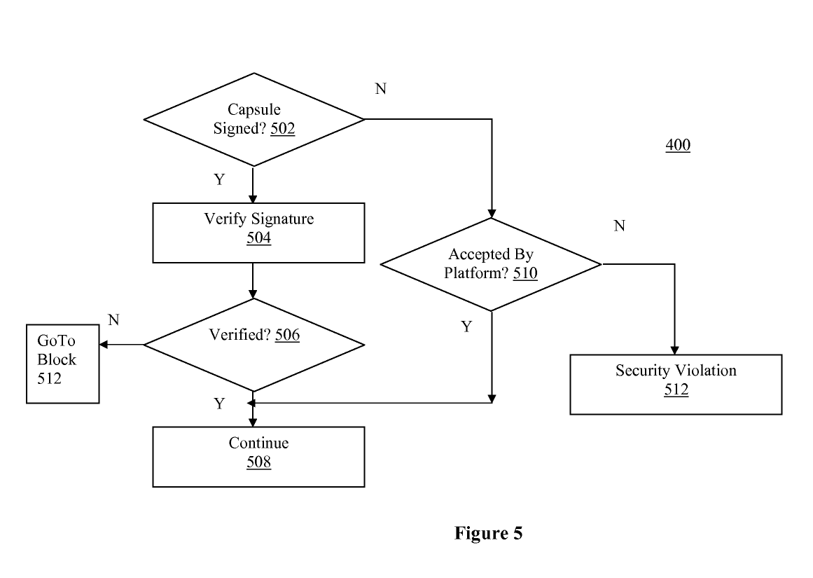

Referring now to FIG. 5, wherein an example process for verifying a capsule, according to various embodiments, is illustrated. Example process 500 for verifying a capsule may include operations performed at blocks 502-512. The operations at blocks 502-512 may be performed e.g., by initialization service 126 of firmware 110 of FIG. 1. In alternate embodiments, process 500 may include more or less operations, or some of the operations may be performed in different order.

Process 500 may begin at block 502. At block 502, a determination may be made on whether the capsule is signed. If the capsule is signed, process 500 may proceed to block 504. At block 504, an attempt may be made to verify the signature. At block 506, a determination may be made on whether the attempt to verify the signature was successful. If the verification was successful, processing may continue at block 508. If the verification is unsuccessful, process 500 may proceed to block 512.

Back at block 502, if the capsule is not signed, process 500 may proceed to block 510. At block 510, another determination may be made on whether an unsigned capsule is acceptable to the platform. The determination may be made on a platform dependent manner. If an unsigned capsule is acceptable to the platform, process 500 may proceed to block 508, and continue therefrom as earlier described, else process 500 may proceed to block 512.

At block 512, a security violation has been determined. The security violation may be disposed in a platform dependent manner. In embodiments, the platform may be shut down and disabled.

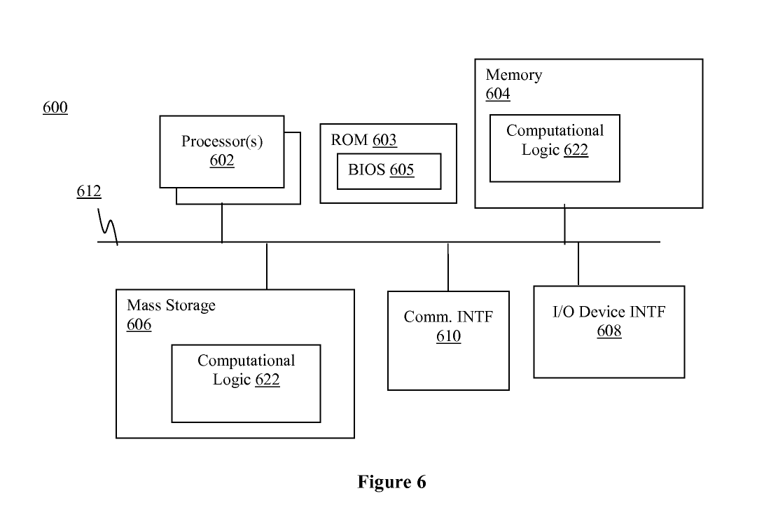

FIG. 6 illustrates an example computer system that may be suitable for use to practice selected aspects of the present disclosure. As shown, computer 600 may include one or more processors or processor cores 602, read-only memory (ROM) 603, and system memory 604. For the purpose of this application, including the claims, the term “processor” refers to a physical processor, and the terms “processors” and “processor cores” may be considered synonymous, unless the context clearly requires otherwise. Additionally, computer system 600 may include mass storage devices 606. Example of mass storage devices 606 may include, but are not limited to, tape drives, hard drives, compact disc read-only memory (CD-ROM) and so forth). Further, computer system 600 may include input/output devices 608 (such as display, keyboard, cursor control and so forth) and communication interfaces 610 (such as network interface cards, modems and so forth). The elements may be coupled to each other via system bus 612, which may represent one or more buses. In the case of multiple buses, they may be bridged by one or more bus bridges (not shown).

Each of these elements may perform its conventional functions known in the art. In particular, ROM 603 may include basic input/output system services (BIOS) 605, including initialization service 126 and reset service 128 of FIG. 1, as earlier described. System memory 604 and mass storage devices 606 may be employed to store a working copy and a permanent copy of the programming instructions implementing the operations associated with applications 112 and guest OS 114, as earlier described, collectively referred to as computational logic 622. The various elements may be implemented by assembler instructions supported by processor(s) 602 or high-level languages, such as, for example, C, that can be compiled into such instructions.

The number, capability and/or capacity of these elements 610-612 may vary, depending on whether computer system 600 is used as a mobile device, such as a wearable device, a smartphone, a computer tablet, a laptop and so forth, or a stationary device, such as a desktop computer, a server, a game console, a set-top box, an infotainment console, and so forth. Otherwise, the constitutions of elements 610-612 are known, and accordingly will not be further described.

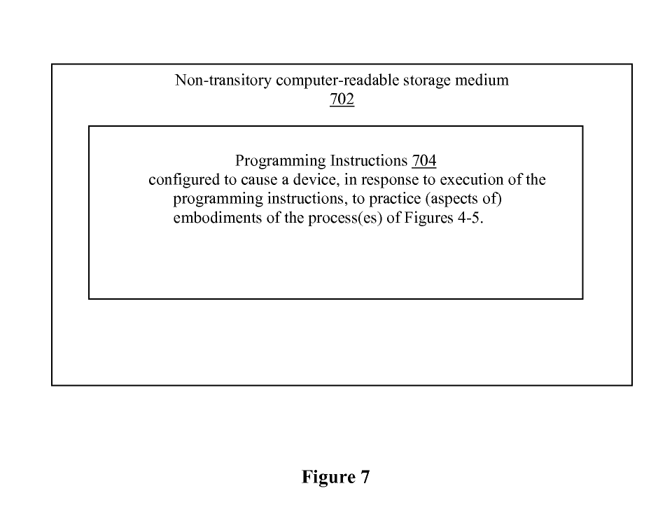

As will be appreciated by one skilled in the art, the present disclosure may be embodied as methods or computer program products. Accordingly, the present disclosure, in addition to being embodied in hardware as earlier described, may take the form of an entirely software embodiment (including firmware, resident software, micro-code, etc.) or an embodiment combining software and hardware aspects that may all generally be referred to as a “circuit,” “module” or “system.” Furthermore, the present disclosure may take the form of a computer program product embodied in any tangible or non-transitory medium of expression having computer-usable program code embodied in the medium. FIG. 7 illustrates an example computer-readable non-transitory storage medium that may be suitable for use to store instructions that cause an apparatus, in response to execution of the instructions by the apparatus, to practice selected aspects of the present disclosure. As shown, non-transitory computer-readable storage medium 702 may include a number of programming instructions 704. Programming instructions 704 may be configured to enable a device, e.g., computer 600, in response to execution of the programming instructions, to implement (aspects of) firmware 110, OS 112, and/or applications 114. In alternate embodiments, programming instructions 704 may be disposed on multiple computer-readable non-transitory storage media 702 instead. In still other embodiments, programming instructions 704 may be disposed on computer-readable transitory storage media 702, such as, signals.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a,” “an” and “the” are intended to include plural forms as well, unless the context clearly indicates otherwise. It will be further understood that the terms “comprises” and/or “comprising,” when used in this specification, specific the presence of stated features, integers, steps, operations, elements, and/or components, but do not preclude the presence or addition of one or more other features, integers, steps, operation, elements, components, and/or groups thereof.

Embodiments may be implemented as a computer process, a computing system or as an article of manufacture such as a computer program product of computer readable media. The computer program product may be a computer storage medium readable by a computer system and encoding a computer program instructions for executing a computer process.

The corresponding structures, material, acts, and equivalents of all means or steps plus function elements in the claims below are intended to include any structure, material or act for performing the function in combination with other claimed elements are specifically claimed. The description of the present disclosure has been presented for purposes of illustration and description, but is not intended to be exhaustive or limited to the disclosure in the form disclosed. Many modifications and variations will be apparent to those of ordinary skill without departing from the scope and spirit of the disclosure. The embodiment was chosen and described in order to best explain the principles of the disclosure and the practical application, and to enable others of ordinary skill in the art to understand the disclosure for embodiments with various modifications as are suited to the particular use contemplated.

Referring back to FIG. 6, for one embodiment, at least one of processors 602 may be packaged together with memory having aspects of firmware 110 and/or OS 112. For one embodiment, at least one of processors 602 may be packaged together with memory having aspects of firmware 110 and/or OS 112 to form a System in Package (SiP). For one embodiment, at least one of processors 602 may be integrated on the same die with memory having aspects of firmware 110 and/or OS 112. For one embodiment, at least one of processors 602 may be packaged together with memory having aspects of firmware 110 and/or OS 112 to form a System on Chip (SoC). For at least one embodiment, the SoC may be utilized in, e.g., but not limited to, a smartphone or computing tablet.

Thus various example embodiments of the present disclosure have been described including, but are not limited to:

Example 1 may be an apparatus for computing, comprising: one or more processors, and memory; firmware coupled with the one or more processors and memory to provide basic input/output services to an operating system operated by the one or more processors; a memory controller coupled with the memory to control access to the memory, wherein the memory controller may include an encryption engine to encrypt data, using an encryption key, before the data are stored into an encrypted area of the memory, wherein the encryption engine regenerates the encryption key on a reset transferring execution from the operating system operated by the one or more processors to a pre-boot phase of the firmware; and one or more storage locations to store one or more memory parameters to set aside one or more ranges of the memory as one or more encryption excluded areas.

Example 2 may be example 1, wherein the one or more storage locations may comprise a first storage location to store a base address of a first of the one or more encryption excluded areas, and a second storage location to store an address mask to effectively define a range of the first encryption excluded area extending from the base address.

Example 3 may be example 1, wherein the one or more storage locations may comprise one or more registers of the memory controller.

Example 4 may be example 1, wherein the basic input/output services of the firmware may include one or more encryption exclusion services that configure the one or more memory parameters to set aside the one or more ranges of the memory to provide the one or more encryption excluded areas of the memory or unset one or more previously set aside ranges of the memory to no longer exclude the one or more areas from encryption.

Example 5 may be example 4, wherein the basic input/output services of the firmware may include a system reset service, wherein the system reset service may include a first of the one or more encryption exclusion services, wherein the first encryption exclusion service, on invocation during a beginning of a reset transferring execution from the operating system to the pre-boot phase of the firmware, may set the one or more memory parameters to set aside one or more ranges of the memory as the one or more encryption excluded areas.

Example 6 may be example 5, wherein the basic input/output services of the firmware may include a system initialization service; and wherein the system reset service, on setting aside one or more ranges of the memory as the one or more encryption excluded areas, may perform a warm start to enter the apparatus into a boot phase, and to invoke the system initialization service to initialize the apparatus.

Example 7 may be example 6, wherein the system initialization service may include a second of the one or more encryption exclusion services; wherein the second encryption exclusion service, on invocation at an end of the initialization phase, may reset the one or more memory parameters to unset the set aside one or more ranges of the memory to no longer exclude the one or more areas from encryption.

Example 8 may be any one of examples 4-7, wherein the basic input/output services of the firmware may include a system initialization service, wherein the system initialization service may include a first of the one or more encryption exclusion services, wherein the first encryption exclusion service, on invocation during initialization of the apparatus, may set the one or more memory parameters to set aside one or more ranges of the memory as the one or more encryption excluded areas.

Example 9 may be any one of examples 4-7, wherein the basic input/output services of the firmware may include a system reset service, wherein the system reset service, as part of resetting the apparatus, may copy a capsule created by the operating system from the encrypted area into the one or more of the one or more encryption excluded areas.

Example 10 may be example 9, wherein the basic input/output services of the firmware may further include a system initialization service; and wherein the system initialization service may process the capsule during the pre-boot phase of the apparatus.

Example 11 may be a method for computing, comprising: controlling, by a memory controller of a computing device, accesses to memory of the computing device, wherein controlling may include encrypting data, using an encryption key, before the data are stored into an encrypted area of the memory, and regenerating the encryption key on a reset transferring execution from an operating system being operated by one or more processors of the computing device to a pre-boot phase of firmware of the computing device; and configuring, by basic input/output services of the firmware, one or more memory parameters to set aside one or more ranges of the memory as one or more encryption excluded areas of the memory.

Example 12 may be example 11, wherein configuring may comprise configuring a first storage location to store a base address of a first of the one or more encryption excluded areas, and a second storage location to store an address mask to effectively define a range of the first encryption excluded area extending from the base address.

Example 13 may be example 11, wherein configuring may comprise one or more encryption exclusion services of the basic input/output services of the firmware configuring the one or more memory parameters to set aside the one or more ranges of the memory to provide the one or more encryption excluded areas of the memory or unset one or more previously set aside ranges of the memory to no longer exclude the one or more areas from encryption.

Example 14 may be example 13, wherein the basic input/output services of the firmware may include a system reset service, wherein the system reset service may include a first of the one or more encryption exclusion services, wherein configuring may comprise the first encryption exclusion service, on invocation during a beginning of a reset transferring execution from the operating system to the pre-boot phase of the firmware, setting the one or more memory parameters to set aside one or more ranges of the memory as the one or more encryption excluded areas.

Example 15 may be example 14, wherein the basic input/output services of the firmware may include a system initialization service; and wherein the method further may comprise the system reset service, on setting aside one or more ranges of the memory as the one or more encryption excluded areas, performing a warm start to enter the computing device into a boot phase, and invoking the system initialization service to initialize the computing device.

Example 16 may be example 15, wherein the system initialization service may include a second of the one or more encryption exclusion services; wherein the method further may comprise the second encryption exclusion service, on invocation at an end of the initialization phase, resetting the one or more memory parameters to unset the set aside one or more ranges of the memory to no longer exclude the one or more areas from encryption.

Example 17 may be any one of examples 13-16, wherein the basic input/output services of the firmware may include a system initialization service, wherein the system initialization service may include a first of the one or more encryption exclusion services, wherein configuring may comprise the first encryption exclusion service, on invocation during initialization of the apparatus, setting the one or more memory parameters to set aside one or more ranges of the memory as the one or more encryption excluded areas.

Example 18 may be any one of examples 13-16, wherein the basic input/output services of the firmware may include a system reset service, wherein the method further may comprise the system reset service, as part of resetting the computing device, copying a capsule created by the operating system from the encrypted area into the one or more of the one or more encryption excluded areas.

Example 19 may be example 18, wherein the basic input/output services of the firmware may further include a system initialization service; and wherein the method further may comprise the system initialization service processing the capsule during the pre-boot phase of the apparatus.

Example 20 may be one or more computer-readable media comprising instructions that cause a computing device, in response to execution of the instructions by a processor of the computing device, to provide basic input/output services to an operating system operated by the processor; wherein provision of basic input/output services may include configuration of one or more memory parameters to set aside one or more ranges of a memory of the computing device as one or more encryption excluded areas; wherein access to the memory is controlled by a memory controller, wherein control of access may include encryption of data, using an encryption key, before the data are stored into an encrypted area of the memory, and regeneration of the encryption key on a reset that transfers execution from the operating system to a pre-boot phase of the firmware.

Example 21 may be example 20, wherein configuration of the one or more storage locations may comprise configuration of a first storage location to store a base address of a first of the one or more encryption excluded areas, and a second storage location to store an address mask to effectively define a range of the first encryption excluded area extending from the base address.

Example 22 may be example 20, wherein the basic input/output services of the firmware may include one or more encryption exclusion services that configure the one or more memory parameters to set aside the one or more ranges of the memory to provide the one or more encryption excluded areas of the memory or unset one or more previously set aside ranges of the memory to no longer exclude the one or more areas from encryption.

Example 23 may be example 22, wherein the basic input/output services of the firmware may include a system reset service, wherein the system reset service may include a first of the one or more encryption exclusion services, wherein the first encryption exclusion service, on invocation during a beginning of a reset transferring execution from the operating system to the pre-boot phase of the firmware, may set the one or more memory parameters to set aside one or more ranges of the memory as the one or more encryption excluded areas.

Example 24 may be example 23, wherein the basic input/output services of the firmware may include a system initialization service; and wherein the system reset service, on setting aside one or more ranges of the memory as the one or more encryption excluded areas, may perform a warm start to enter the computing device into a boot phase, and invokes the system initialization service to initialize the computing device.

Example 25 may be example 24, wherein the system initialization service may include a second of the one or more encryption exclusion services; wherein the second encryption exclusion service, on invocation at an end of the initialization phase, may reset the one or more memory parameters to unset the set aside one or more ranges of the memory to no longer exclude the one or more areas from encryption.

Example 26 may be example, wherein the basic input/output services of the firmware may include a system initialization service, wherein the system initialization service may include a first of the one or more encryption exclusion services, wherein the first encryption exclusion service, on invocation during initialization of the computing device, may set the one or more memory parameters to set aside one or more ranges of the memory as the one or more encryption excluded areas.

Example 27 may be example, wherein the basic input/output services of the firmware may include a system reset service, wherein the system reset service, as part of resetting the computing device, may copy a capsule created by the operating system from the encrypted area into the one or more of the one or more encryption excluded areas.

Example 28 may be example, wherein the basic input/output services of the firmware may further include a system initialization service; and wherein the system initialization service may process the capsule during the pre-boot phase of the computing device.

Example 29 may be an apparatus for computing, comprising: means for controlling accesses to memory of a computing device, wherein means for controlling may include means for encrypting data, using an encryption key, before the data are stored into an encrypted area of the memory, and means for regenerating the encryption key on a reset transferring execution from an operating system being operated by one or more processors of the computing device to a pre-boot phase of firmware of the computing device; and means for configuring one or more memory parameters to set aside one or more ranges of the memory as one or more encryption excluded areas of the memory.

Example 30 may be example 29, wherein means for configuring may comprise means for configuring a first storage location to store a base address of a first of the one or more encryption excluded areas, and a second storage location to store an address mask to effectively define a range of the first encryption excluded area extending from the base address.

Example 31 may be example 29, wherein means for configuring may comprise one or more means for excluding encryption having means for configuring the one or more memory parameters to set aside the one or more ranges of the memory to provide the one or more encryption excluded areas of the memory or unset one or more previously set aside ranges of the memory to no longer exclude the one or more areas from encryption.

Example 32 may be example 31, further comprising means for resetting the apparatus, including one of the means for excluding encryption for, on invocation during a beginning of a reset transferring execution from the operating system to the pre-boot phase of the firmware, setting the one or more memory parameters to set aside one or more ranges of the memory as the one or more encryption excluded areas.

Example 33 may be example 32, further comprising means for initializing the apparatus, including the means for resetting the apparatus, for, on setting aside one or more ranges of the memory as the one or more encryption excluded areas, performing a warm start to enter the apparatus into a boot phase, and initializing the apparatus.

Example 34 may be example 33, wherein the means for initializing the apparatus may include a second of the means for excluding encryption for, on invocation at an end of the initialization phase, resetting the one or more memory parameters to unset the set aside one or more ranges of the memory to no longer exclude the one or more areas from encryption.

Example 35 may be example 31-34, wherein the means for initializing the apparatus may include a first of the means for excluding encryption, for, on invocation during initialization of the apparatus, setting the one or more memory parameters to set aside one or more ranges of the memory as the one or more encryption excluded areas.

Example 36 may be example 31-34, further comprising means for resetting the apparatus for, as part of resetting the apparatus, copying a capsule created by the operating system from the encrypted area into the one or more of the one or more encryption excluded areas.

Example 37 may be example 36, further comprising means for initializing the apparatus for processing the capsule during the pre-boot phase of the apparatus.

It will be apparent to those skilled in the art that various modifications and variations can be made in the disclosed embodiments of the disclosed device and associated methods without departing from the spirit or scope of the disclosure. Thus, it is intended that the present disclosure covers the modifications and variations of the embodiments disclosed above provided that the modifications and variations come within the scope of any claims and their equivalents.

What is claimed is:

1. An apparatus for computing, comprising:
one or more processors, and memory;
firmware coupled with the one or more processors and memory to provide basic input/output services to an operating system operated by the one or more processors;
a memory controller coupled with the memory to control access to the memory, wherein the memory controller includes an encryption engine to encrypt data, using an encryption key, before the data are stored into an encrypted area of the memory, wherein the encryption engine regenerates the encryption key on a reset transferring execution from the operating system operated by the one or more processors to a pre-boot phase of the firmware; and
one or more storage locations to store one or more memory parameters to set aside one or more ranges of the memory as one or more encryption excluded areas.

2. The apparatus of claim 1, wherein the one or more storage locations comprise a first storage location to store a base address of a first of the one or more encryption excluded areas, and a second storage location to store an address mask to effectively define a range of the first encryption excluded area extending from the base address.

3. The apparatus of claim 1, wherein the one or more storage locations comprise one or more registers of the memory controller.

4. The apparatus of claim 1, wherein the basic input/output services of the firmware include one or more encryption exclusion services that configure the one or more memory parameters to set aside the one or more ranges of the memory to provide the one or more encryption excluded areas of the memory or unset one or more previously set aside ranges of the memory to no longer exclude the one or more areas from encryption.

5. The apparatus of claim 4, wherein the basic input/output services of the firmware include a system reset service, wherein the system reset service includes a first of the one or more encryption exclusion services, wherein the first encryption exclusion service, on invocation during a beginning of a reset transferring execution from the operating system to the pre-boot phase of the firmware, is to set the one or more memory parameters to set aside one or more ranges of the memory as the one or more encryption excluded areas.

6. The apparatus of claim 5, wherein the basic input/output services of the firmware include a system initialization service; and wherein the system reset service, on setting aside one or more ranges of the memory as the one or more encryption excluded areas, is to perform a warm start to enter the apparatus into a boot phase, and to invoke the system initialization service to initialize the apparatus.

7. The apparatus of claim 6, wherein the system initialization service includes a second of the one or more encryption exclusion services; wherein the second encryption exclusion service, on invocation at an end of the initialization phase, is to reset the one or more memory parameters to unset the set aside one or more ranges of the memory to no longer exclude the one or more areas from encryption.

8. The apparatus of claim 4, wherein the basic input/output services of the firmware include a system initialization service, wherein the system initialization service includes a first of the one or more encryption exclusion services, wherein the first encryption exclusion service, on invocation during initialization of the apparatus, is to set the one or more memory parameters to set aside one or more ranges of the memory as the one or more encryption excluded areas.

9. The apparatus of claim 4, wherein the basic input/output services of the firmware include a system reset service, wherein the system reset service, as part of resetting the apparatus, is to copy a capsule created by the operating system from the encrypted area into the one or more of the one or more encryption excluded areas.

10. The apparatus of claim 9, wherein the basic input/output services of the firmware further include a system initialization service; and wherein the system initialization service is to process the capsule during the pre-boot phase of the apparatus.

11. A method for computing, comprising:
controlling, by a memory controller of a computing device, accesses to memory of the computing device, wherein controlling includes encrypting data, using an encryption key, before the data are stored into an encrypted area of the memory, and regenerating the encryption key on a reset transferring execution from an operating system being operated by one or more processors of the computing device to a pre-boot phase of firmware of the computing device; and
configuring, by basic input/output services of the firmware, one or more memory parameters to set aside one or more ranges of the memory as one or more encryption excluded areas of the memory.

12. The method of claim 11, wherein configuring comprises configuring a first storage location to store a base address of a first of the one or more encryption excluded areas, and a second storage location to store an address mask to effectively define a range of the first encryption excluded area extending from the base address.

13. The method of claim 11, wherein configuring comprises one or more encryption exclusion services of the basic input/output services of the firmware configuring the one or more memory parameters to set aside the one or more ranges of the memory to provide the one or more encryption excluded areas of the memory or unset one or more previously set aside ranges of the memory to no longer exclude the one or more areas from encryption.

14. The method of claim 13, wherein the basic input/output services of the firmware include a system reset service, wherein the system reset service includes a first of the one or more encryption exclusion services, wherein configuring comprises the first encryption exclusion service, on invocation during a beginning of a reset transferring execution from the operating system to the pre-boot phase of the firmware, setting the one or more memory parameters to set aside one or more ranges of the memory as the one or more encryption excluded areas.

15. The method of claim 14, wherein the basic input/output services of the firmware include a system initialization service; and wherein the method further comprises the system reset service, on setting aside one or more ranges of the memory as the one or more encryption excluded areas, performing a warm start to enter the computing device into a boot phase, and invoking the system initialization service to initialize the computing device.

16. The method of claim 15, wherein the system initialization service includes a second of the one or more encryption exclusion services; wherein the method further comprises the second encryption exclusion service, on invocation at an end of the initialization phase, resetting the one or more memory parameters to unset the set aside one or more ranges of the memory to no longer exclude the one or more areas from encryption.

17. The method of claim 13, wherein the basic input/output services of the firmware include a system initialization service, wherein the system initialization service includes a first of the one or more encryption exclusion services, wherein configuring comprises the first encryption exclusion service, on invocation during initialization of the apparatus, setting the one or more memory parameters to set aside one or more ranges of the memory as the one or more encryption excluded areas.

18-25. (canceled)
